(19) United States
(12) Patent Application Publication
(10) Pub. No.: US 2009/0240611 A1
(43) Pub. Date: Sep. 24, 2009

(54) SYSTEMS AND METHODS FOR DISPLAYING A DATA MODIFICATION TIMELINE

(76) Inventors: Nancy L. Augustine, Pleasant Hill, CA (US); John Carr, Antioch, CA (US); Ben Goldberg, Pleasanton, CA (US); Randall Jones, Carrollton, TX (US); Charyl L. Paterson, Alameda, CA (US); Ev Shafrir, Mountain View, CA (US); Gregg Stratton, San Francisco, CA (US)

Correspondence Address: WILSON SONSINI GOODRICH & ROSATI, 650 PAGE MILL ROAD, PALO ALTO, CA, 94304-1050, US

(21) Appl. No.: 12/053,498

(22) Filed: Mar. 21, 2008

(51) Int. Cl. G06Q 30/00; G06Q 10/00

(52) U.S. Cl. 705/32; 705/1

(57) ABSTRACT

Systems and methods for displaying data modification may include a user interface displaying a timeline with one or more items, which may include their own item timeline, corresponding to the same time period. A change made in item values may be reflected in the timeline. The invention may be applied to payroll or human capital management software, which may provide means for displaying payroll or human capital management information and how it is modified.

### FIELD OF THE INVENTION

This invention is directed to systems and methods of displaying data modification. The invention may be applied to payroll or human capital management software, which may provide means for displaying data modification of payroll or other human capital management information of employees.

### BACKGROUND OF THE INVENTION

Every employer is faced with the regular generation of payroll for its employees. Initially, payroll processing was an arduous manual task, requiring the responsible individual to compute the base pay, applicable taxes, and other deductions for each of the employer's employees. Initially, these calculations were performed by hand. Over time, automated systems have been developed to calculate pay, produce payroll checks, and even to make the automatic payroll deposits into an employee's bank account for employees participating in a direct deposit program. Automated systems have also been developed to deal with overall human capital management.

Prior payroll automation and human capital management systems generally provide an employer with the ability to analyze the payroll or to modify payroll data or parameters, or to management other human capital data. However, such payroll automation and human capital management systems may not provide a user display of payroll information that may show earlier values of payroll data and new values of payroll data over time and when any changes in payroll data may occur. Such payroll or human capital management systems may also fail to visually incorporate time, so that modifications made to payroll or other human capital management data may be reflected in a manner that relates to time.

There is a need for improved systems and methods for displaying data modification, especially for data including payroll and human capital management data, in a visually intuitive manner that may indicate change in data, which may reflect the passage of time.

### SUMMARY OF THE INVENTION

The invention provides systems and methods for displaying data modification. Various aspects of the invention described herein may be applied to any of the particular applications set forth below or for any other types of user interfaces and displays. The invention may be applied as a standalone system or method, or as part of an integrated software package, such as for payroll or human capital management software. It shall be understood that different aspects of the invention can be appreciated individually, collectively, or in combination with each other.

An aspect of the invention provides for a user interface shown on a display. For example, the implementation of software may include a client computer comprising a video display, with at least one display page comprising data. The data may include human capital management data, which may include data such as payroll data (including items such as wage compensation and benefits), workforce planning, recruitment, induction/orientation, skills management, training and development, personnel administration, time management, travel management, personnel cost planning, or performance appraisal.

Another aspect of the invention provides for a user interface which may include a graphical timeline displaying one or more item, each with its own item timeline. A graphical timeline may display one or more human capital management item timelines. An item may include any type of data item. For example, the timeline may display items relating to human capital management data, which may include data such as payroll data (including items such as wage compensation and benefits), workforce planning, recruitment, induction/orientation, skills management, training and development, personnel administration, time management, travel management, personnel cost planning, or performance appraisal which may include items relating to taxes, earnings, deductions, direct deposit, personal information, time off, and so forth.

In another embodiment of the invention, items may also be directed to other pivot points of data. The pivot point may include any item of characterization. In a preferable implementation of the invention, a pivot point may be for an employee, so that a timeline may include item timelines for various data, such as human capital management data as mentioned previously. In another example, a pivot point could be a particular type of data, such as 401(k), and a timeline may include item timelines for various employees as the items. The item timelines for each employee may show each employee's 401(k) values and how they change.

In one embodiment of the invention, each item timeline may include an initial data value for the item at the earliest time period on the timeline if an initial data value exists at the earliest time period. An item timeline may also include a change indicator, if a data value of an item has changed, and the change indicator may appear on the item timeline so that it may correspond to a time where the data value of the item has changed. A data value of an item may be displayed as a new data value if the data value has changed. In a preferable embodiment of the invention, the data values may relate to payroll or any other human capital management data.

The timeline may have a number of orientations. In a preferable embodiment of the invention, the timeline may have a horizontal orientation with earlier times to the left and later times to the right. Each item timeline may be parallel to the timeline and may have the same orientation and relate to the same period of time.

The timeline may have additional features, such as time period indicators, which may be any visual indication of any time periods within the time period encompassed by the timeline. In a preferable embodiment of the invention, time period indicators may indicate pay periods. The timeline may also include time passage indicators which may correspond to a calendar time period. The timeline may also include a feature that when a user interacts with the timeline, such as by placing a pointing device indicator such as a mouse cursor over an item timeline, information about an item may be displayed. The timeline may include other features, such as means to add or remove an item from the timeline, or may display any additional information.

In accordance with another aspect of the invention, the timeline may reflect a change made using a various means for data modification. In one embodiment of the invention, the means for data modification may include a side by side display. In one implementation, the timeline and side by side display may be displayed together.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The features and advantages of the invention may be further explained by reference to the following detailed description and accompanying drawings that sets forth illustrative embodiments.

FIG. 1 shows a system with client computers interacting with a server over a network.

FIG. 2 shows a timeline with items and item timelines.

FIG. 3 shows an interaction between an item timeline and a pointing device indicator in accordance with one embodiment of the invention.

FIG. 4 shows an embodiment of the item timeline.

FIG. 5 shows an embodiment of a user interface including a data modification interface, and a corresponding timeline.

FIG. 6 shows an embodiment of a user interface including a side by side display, and a corresponding timeline.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

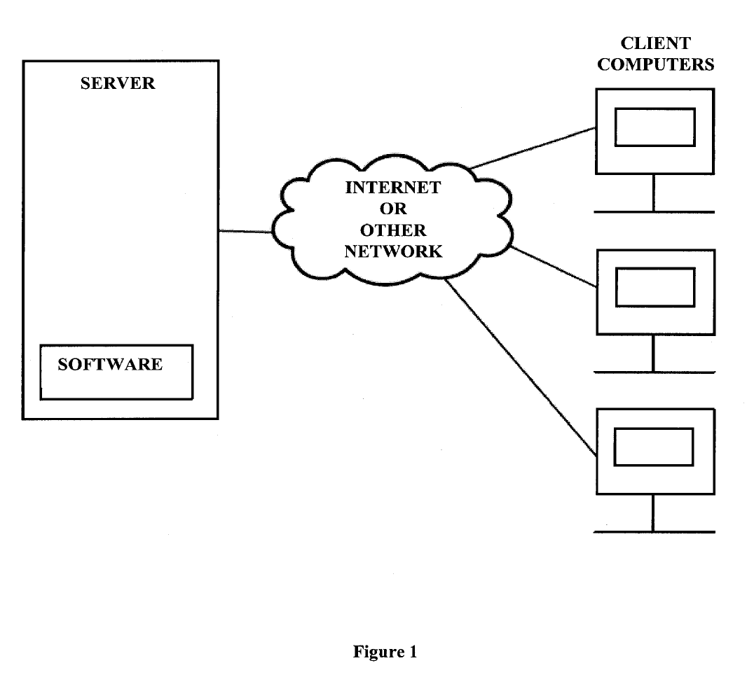

A user interface provided in accordance with the invention herein may be displayed across a network such as the Internet. For example, as shown in FIG. 1, an implementation of may include a client computer comprising a video display with at least one display page comprising data. The data may include human capital management data, which may include data such as payroll data (including items such as wage compensation and benefits), workforce planning, recruitment, induction/orientation, skills management, training and development, personnel administration, time management, travel management, personnel cost planning, or performance appraisal. Human capital management data may include data that can be person and time dependent. Human capital management may be heterogeneous across different businesses and a human capital management outsourcing software may advantageously display human capital management data.

Video displays may include devices upon which information may be displayed in a manner perceptible to a user, such as, for example, a computer monitor, cathode ray tube, liquid crystal display, light emitting diode display, touchpad or touchscreen display, and/or other means known in the art for emitting a visually perceptible output. Video displays may be electronically connected to a client computer according to hardware and software known in the art.

In one implementation of the invention, a display page may include a computer file residing in memory which is transmitted from a server over a network to a client computer, which can store it in memory. Similarly, one or more servers may communicate with one or more client computers across a network, and may transmit computer files residing in memory. The network, for example, can include the Internet or any network for connecting one or more clients to one or more servers.

At the client computer, the display page may be interpreted by software residing on a memory of the client computer, causing the computer file to be displayed on a video display in a manner perceivable by a user. The display pages described herein may be created using a software language known in the art such as, for example, the hypertext mark up language (“HTML”), the dynamic hypertext mark up language (“DHTML”), the extensible hypertext mark up language (“XHTML”), the extensible mark up language (“XML”), or another software language that may be used to create a computer file displayable on a video display in a manner perceivable by a user. Where network comprises the Internet, a display page may comprise a webpage of a type known in the art.

A display page according to the invention may include embedded functions comprising software programs stored on a memory, such as, for example, VBScript routines, JScript routines, JavaScript routines, Java applets, ActiveX components, ASP.NET, AJAX, Flash applets, Silverlight applets, or AIR routines.

A display page may comprise well known features of graphical user interface technology, such as, for example, frames, windows, scroll bars, buttons, icons, and hyperlinks, and well known features such as a “point and click” interface. Pointing to and clicking on a graphical user interface button, icon, or hyperlink also is known as “selecting” the button or hyperlink. A display page according to the invention also may incorporate multimedia features.

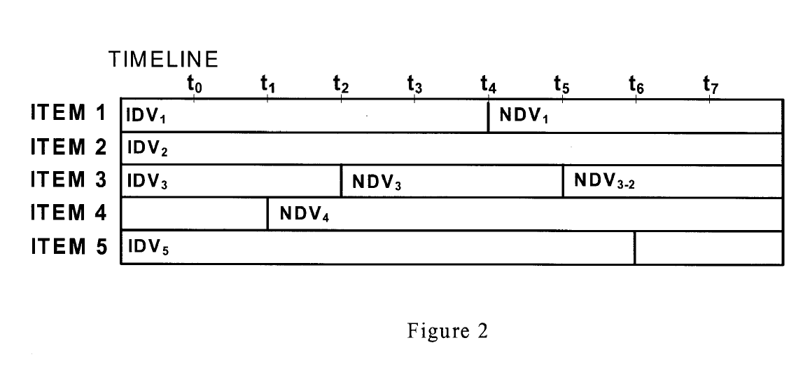

Referring to the drawings in detail, FIG. 2 shows a user interface provided in accordance with the invention that may include a graphical timeline, which may include items and item timelines. The aspect of the invention may provide for a user interface which may include a timeline displaying one or more item, each with its own item timeline. A graphical timeline may include payroll or human capital management items and payroll or human capital management item timelines.

An item may include any type of data item. In a preferable implementation, the timeline may display items relating to human capital management data, which may include data such as payroll data (including items such as wage compensation and benefits), workforce planning, recruitment, induction/orientation, skills management, training and development, personnel administration, time management, travel management, personnel cost planning, or performance appraisal. Similarly, the timeline may display items relating to payroll data, which may include items relating to taxes, earnings, deductions, direct deposit, personal information, time off, and so forth. For example, items relating to deductions may include items relating to retirement, such as 401 or IRA, or items relating to benefits, such as medical plans, dental plans, or vision plans, or items relating to insurance, such as supplemental life insurance, accident insurance, and any other miscellaneous items.

In another embodiment of the invention, items may also be directed to other pivot points of data. The pivot point may include any item of characterization. In a preferable implementation of the invention, a pivot point may be for an employee, so that a timeline may include item timelines for various data, such as human capital management data as mentioned previously. A user may be provided with options in which items to display for a particular pivot point. In one example, the items shown for a particular employee may be limited by a category. For instance, a user may choose to view items for an employee relating only to deductions, or may choose to review items for an employee relating only to taxes. In this case, one timeline may include items for an employee relating to deductions, such as items relating to retirement, such as 401(k) or IRA, or items relating to benefits, such as medical plans, dental plans, or vision plans, or items relating to insurance, such as supplemental life insurance, accident insurance, and any other miscellaneous items. A user may be able to access an alternate timeline which may display items for the employee relating to another category, such as taxes. Alternatively, a user may be provided with an option to show all items relating to an employee.

In another implementation, a pivot point could be a particular type of data, such as 401(k), and a timeline may include item timelines for various employees as the items. The item timelines for each employee may show each employee's 401(k) values and how they change. Again, a user may be provided with options in which items to display for a particular pivot point. For instance, there may be different employee work groups, so a user may have the option of viewing the 401(k) item timelines for employees within a particular work group. Or alternatively, a user may be able to choose an option to view the 401(k) item timelines for all employees.

In one embodiment of the invention, an item may be labeled for its corresponding item timeline. For example, an item name may appear adjacent to its item timeline. An item name may also appear within an item timeline. In an alternate example, an item timeline may be labeled by another representation of the item, such as an image or symbol.

An item timeline may include a visual timeline for each item. A timeline may include a plurality of visually mapped item timelines. For instance, the item timelines may be arranged to have a parallel orientation to one another so that they may correspond in time to the timeline and to one another. In one example, a timeline may have a particular orientation for a particular passage of time, and each item timeline may be oriented to correspond to the orientation and the passage of time.

An item timeline may be a representation of time with an orientation. For example, an item timeline may include a bar with a width and length. Alternatively, an item timeline may be a line. In another example, an item timeline may have a regular or irregular shape with an orientation and that may show the passage of time. An item timeline may be comprised of a plurality of shapes as long as the plurality of shapes may somehow have an orientation and passage of time, such as a series of circles lined up in a row.

In a preferable embodiment of the invention, a timeline may have a horizontal orientation and an item timeline may also have a horizontal orientation and correspond to the time of the timeline. The horizontal orientation may be such that earlier times may be to the left and later times may be to the right. There may be more than one item timeline, where each item timeline may also have a horizontal orientation and correspond to the time of the timeline. Each item timeline may comprise a bar with a length and width. The item timelines may be parallel to one another and may be stacked alongside one another. For instance, if a timeline included a period of time from March 1st to June 30th, each item timeline may also include a period of time between March 1st and June 30th so that the time of each item timeline referring to a particular time is lined up to the same time within the other item timelines. If the item timelines are oriented horizontally, the same times may run vertically, so that April 15th of one item timeline may be directly vertical to April 15th of another item timeline.

In one embodiment of the invention, the item timelines of a timeline may have the same length. For instance, regardless of the value of item of the item timeline, a visual depiction of the item timeline may start at the beginning of the time included by a timeline and may end at the end of the time included by the timeline. For example, if a timeline included a period of time from March 1st to June 30th, each item timeline may also start at March 1st and end at June 30th so that the times of each item timeline may line up to the same time for the other item timelines. Even if an item timeline did not have a value during this time, a visual depiction of the item timeline may exist for the whole time, even if the value was a nullity for the part of the time, and may be indicated as such on the display.

In an alternate embodiment of the invention, the item timelines of a timeline may have varying lengths. For instance, if a value of an item timeline starts at a particular time within the time period included by the timeline, the item timeline may start at that time. Or if a value of an item timeline ends at a particular time within the time period included by the timeline, the item timeline may end at that time. For example, if a timeline included a period of time from March 1st to June 30th, and an item timeline did not have a value until March 15th, the item timeline may start at March 15th and may end at June 30th. Or if an item timeline had a value that could end on May 1st, the item timeline may start at March 1st and end on May 1st.

Similarly, an item timeline may be broken up if it switches between having values and not having values during a time period included by a timeline. For example, if a timeline included a period of time from March 1st to June 30th, and an item timeline did not have a value starting April 15th, but then would have a new value starting May 15th, the item timeline may start at March 1st and end on April 15th, and then start on May 15th and end at June 30th.

In one implementation, if an item timeline were to have a value beyond the time displayed, the item timeline may provide some sort of visual indication that the item timeline goes beyond the time displayed, as opposed to starting or ending. Such a visual indication may include a color indication, such as a gradual color change at the beginning or end of the displayed item timeline, as opposed to an abrupt color change. In another embodiment, there may be some sort of shape change or addition, such as an arrow pointing beyond the item timeline. The invention may advantageously provide the concept of ongoing time, including the concept of “ever since” and “forever” or “indefinitely.”

A timeline may also include a time period indicator. A time period indicator may be any visual indicator showing the time period included by the timeline. For example, a time period indicator may include a tick mark for a particular time period, such as a pay period. The time period indicator may also include a value indicating which time the time period indicator is indicating. For example, if a timeline included a period of time from March 1st to June 30th, and a time period indicator were indicating pay periods that occur every 10 days, the time period indicators may include tick marks with March 1st, March 11th, March 21st, March 31st, April 10th, and so forth. A time period indicated by a time period indicator may not have to have a uniform length.

In one embodiment of the invention, each item timeline may include a data value for the item of the item timeline. A data value may have any visual representation incorporated into the item timeline. For example, a data value may be shown as a numerical value of an item and may be represented by the number. Alternatively a data value of an item may be represented by a word, a symbol, a pictoral representation, an icon, a color, a pattern, or any combination thereof. Even if a value of an item may be something specific, such as a number, the data value may be represented as something that represents the category, class, or range of the specific value, such as a color representing a range of numbers.

In one embodiment of the invention, each item timeline may include an initial data value for the item at the earliest time period on the timeline if an initial data value exists at the earliest time period. An initial data value may be a data value of the item timeline which may exist at the start of the time period included by the timeline. If a timeline includes a period of time from March 1st to June 30th, an initial data value for an item timeline may be the data value for the item timeline on March 1st. If an item timeline does not have a data value at March 1st, it may not have an initial data value.

An item timeline may also include a change indicator. If a data value of an item has changed, the change indicator may appear on the item timeline so that it may correspond to a time where the data value of the item has changed. A change indicator may be any visual indication that a data value of an item has changed. For example, a change indicator may be represented by a line that divides an item timeline. A change indicator could also include some sort of color change, or change in shape of the item timeline, or some sort of visual symbol or picture or any other cue.

If the value of an item changes, an item timeline may include a new data value for the item. A new data value may or may not be visually displayed in close proximity with a change indicator. A new data value may also be used as a change indicator. In one embodiment of the invention, if an item were to end within the time period included by the timeline, a new data value may not be displayed to indicate the end of item, or a new data value may be displayed to represent a nullity.

In some embodiments of the invention, an item may start or end within the time period included by a timeline. The start or end of an item may be visually indicated. For example, the start or end of an item may be indicated by a bar to divide an item timeline. Or the start or end of an item may be indicated by the start or end of the item timeline itself. In one embodiment of the invention, an item timeline may have a color while it has a value, and the period of time before a start of an item and the period of time after the start of an item may be white. In another embodiment of the invention, an item timeline may be white or some other color, but may have a gradual shading of color toward the start or end of the item timeline.

In one embodiment of the invention, an item timeline may have various color changes that may denote different meanings. For example, an item timeline may have a sudden color change when the data values before and after the color change are distinct and sudden. An item timeline may have a gradual color change when values before and after the color change occur gradually.

In a preferable embodiment of the invention, an item timeline may have a gradual color change at the start and end of the displayed item timeline to represent values that outside the range of the times displayed that are consistent with displayed values. For example, if a particular item were to have a value that were to change on November 1, but the timeline only displays item timelines from July 1 to October 1, the item timeline may have a gradual shading at the end of the portion displayed to indicate that the data value may remain the same for some time after October 1.

In accordance with one embodiment of the invention, a timeline may also include time passage indicators. Like time period indicators, time passage indicators may be any visual indicator showing the passage of time during a time period included by the timeline. For example, a time passage indicator may indicate the passage of time in calendar increments, such as years, months, weeks, or days. A time passage indicator may be used in conjunction with a time period indicator. A time passage indicator may include any visual indication, such as a tick mark that shows a passage of time. The time passage indicator may also include a value indicating which increment of passing time the indicator is indicating.

For instance, if a timeline included a period of time from March 1st to June 30th, and a time period indicator were indicating pay periods that occur every 10 days, the time period indicators may include tick marks with March 1st, March 11th, March 21st, March 31st, April 10th, and so forth. In this example, time passage indicators may indicate every month, which may include putting tick marks where each new month starts, and may include labels for March, April, May, and June.

One embodiment of the invention may include an indicator denoting a time where values of items may be ascertained. The indicator may be any visual indicator showing a particular time within the time period included by the timeline. In one implementation, the indicator may be a bar going across all the item timelines. In another embodiment of the invention, there may be more than one indicator denoting particular times where values of items may be ascertained. The indicator may also include a label, which may or may not describe the significance of the particular time indicated. The indicator may provide a cross-sectional view of the values of the various items at a particular time.

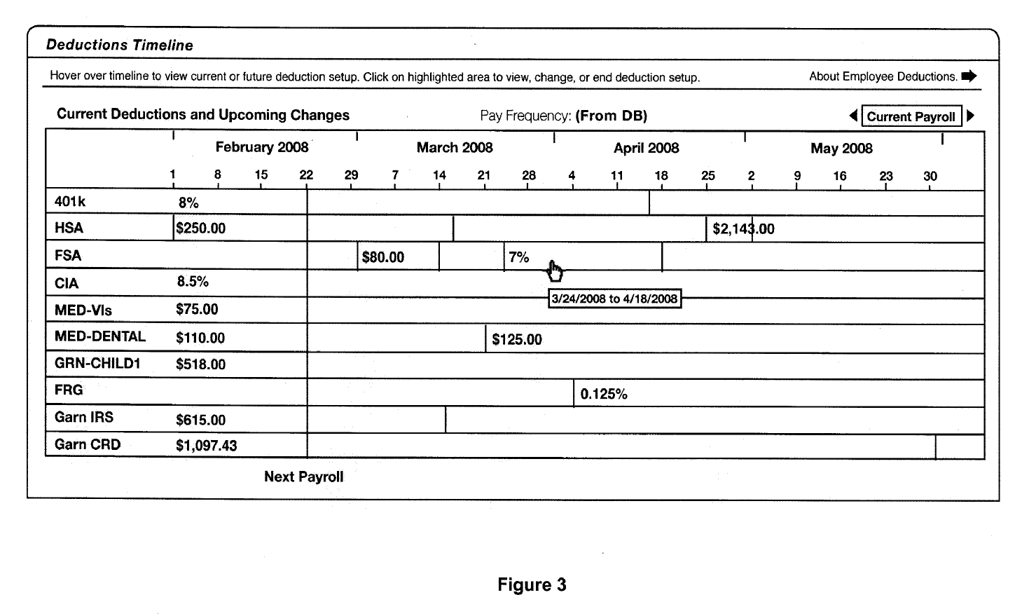

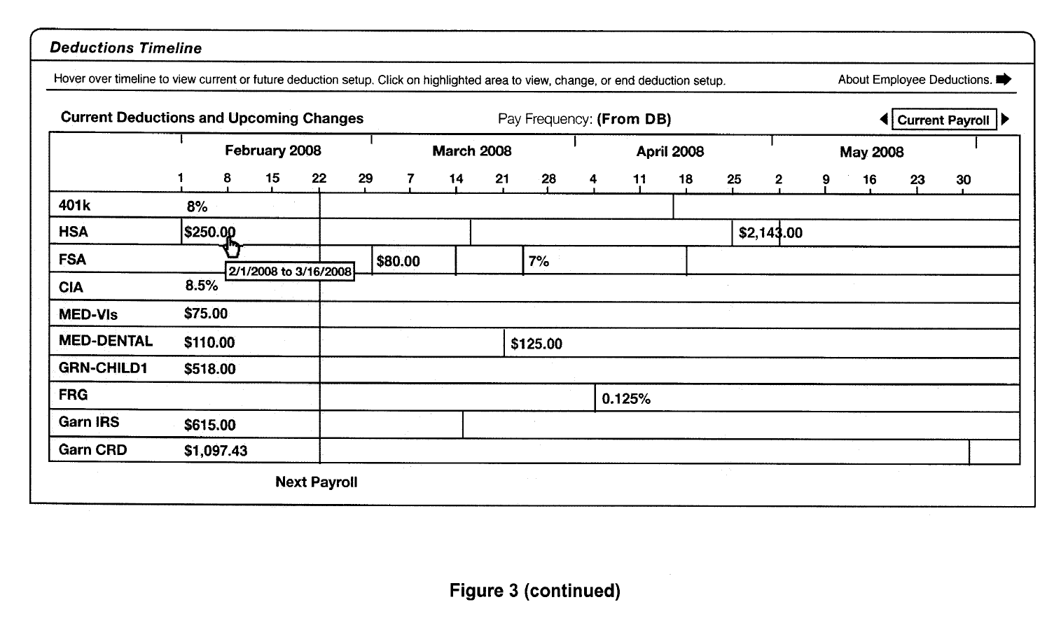

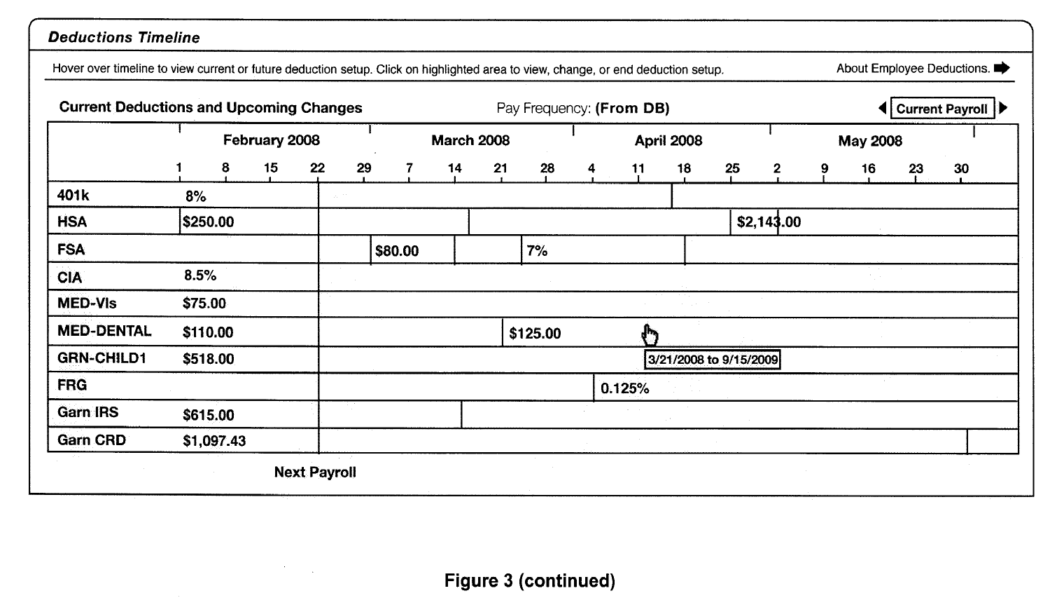

In a preferable embodiment of the invention, the indicator denoting a time where values of items may be ascertained may be indicating the next payroll time, as shown in FIG. 3. The indicator may include a label indicating that the particular time is for the next payroll.

FIG. 3 shows an interaction between an item timeline and a pointing device indicator in accordance with one embodiment of the invention. A user may interact with a display using a number of input-output devices, such as a mouse, trackball, keyboard, touchpad, or any other pointing device. By interacting with an input-output device, such as a mouse, a user may control a pointing device indicator on the display device. For example, common pointing device indicators may include an arrow-like mouse cursor, or pointers of various shapes, such as hands, cross-bars, hourglasses, brushes, or pencils. A pointing device indicator can take any number of visual forms.

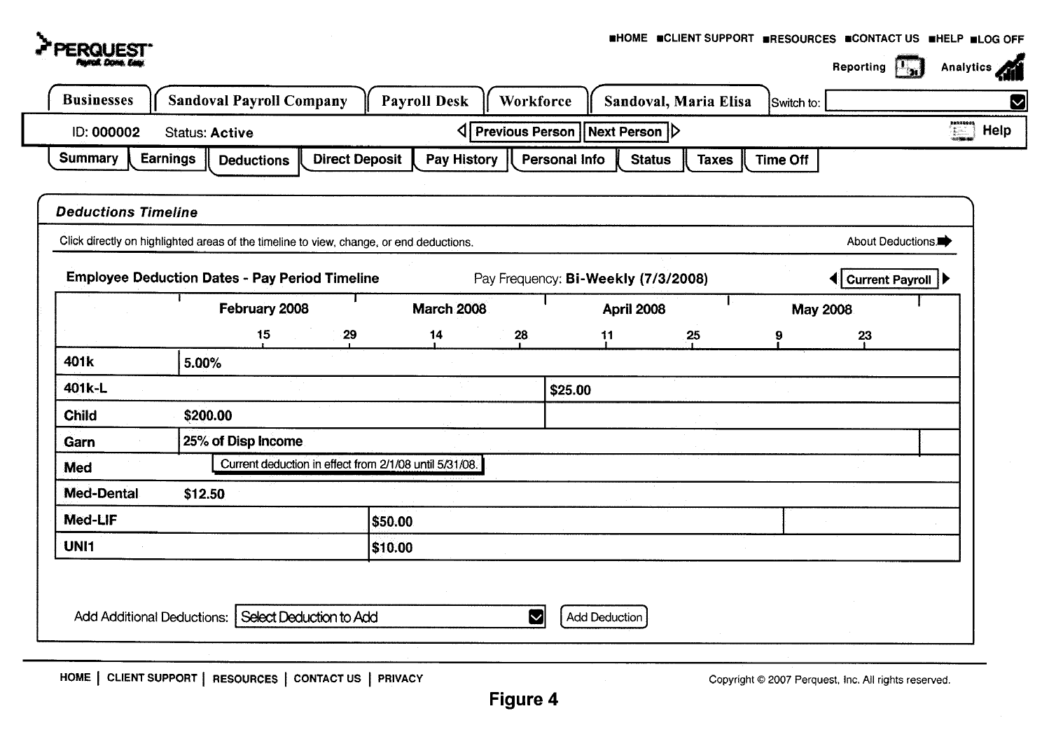

In one implementation of the invention, if a user were to move the pointing device indicator over an item timeline with a data value, the user interface may display information about the item timeline. For example, in a preferable embodiment of the invention, the information may be the period of time for which the item may have that data value. The period of time for which the item may have a data value may include time beyond the time period included by the timeline. In another example, the information may be about the data value of the item timeline as shown in FIG. 4.

The information about an item may be displayed in any visual manner. In a preferable embodiment, the information may be displayed in a popup. The popup may remain as long as the user's pointing device indicator is over the relevant portion of the item timeline. The relevant portion of the item timeline may be the part of the item timeline with a particular data value. The popup may disappear as soon as the user moves the user's mouse so that the indicator is off the item timeline portion, or alternatively, the popup may disappear after a brief delay (i.e. several seconds) from when the user moves the user's indicator off the item timeline portion.

Placing a pointing device indicator on a section of an item timeline may also cause other visual changes in the timeline. For instance, placing a pointing device indicator, such as a mouse cursor over an item timeline may cause that item timeline to change color. This may enable the particular item timeline to stand out. Placing a pointing device indicator over an item timeline may also highlight the item of the item timeline or somehow cause it to be visually distinct from other items in the timeline.

In one embodiment of the invention, if a user were to click on an item timeline, a user may be able to access underlying data. For instance, if a user were to click on an item timeline, a popup may appear with additional information. Alternatively, if a user were to click on an item timeline, a user may navigate toward a different page with data relating to the item. In another example, clicking on an item timeline may result in another window opening with data relating to the item.

A timeline may also include a means to add a new item to an item timeline or to remove an item from an item timeline. For example, the means to add a new item may be a data interaction interface, which may include a field to enter an item, a drop down menu to select an item, or an option to select an item, or any other means of interacting with data.

In some embodiments of the invention, the user interface may include various tabs. FIG. 4 shows one embodiment of the invention where there may be major tabs for information about a business, payroll data, directory of employees, and information about a specific employee. There may also be smaller tabs referring to specific aspects of the information provided by the major tabs. For example, there may be multiple minor tabs, such as under a specific employee, there may be smaller tabs for a taxes, earnings, deductions, direct deposit, summary, personal information, pay history, time off, status, labor, or any other payroll information relating to a specific employee. One of these minor tabs may be selected and may display a timeline relating to the selected tab. The user interface may also include additional navigational tools such as options to select the next employee, and so forth.

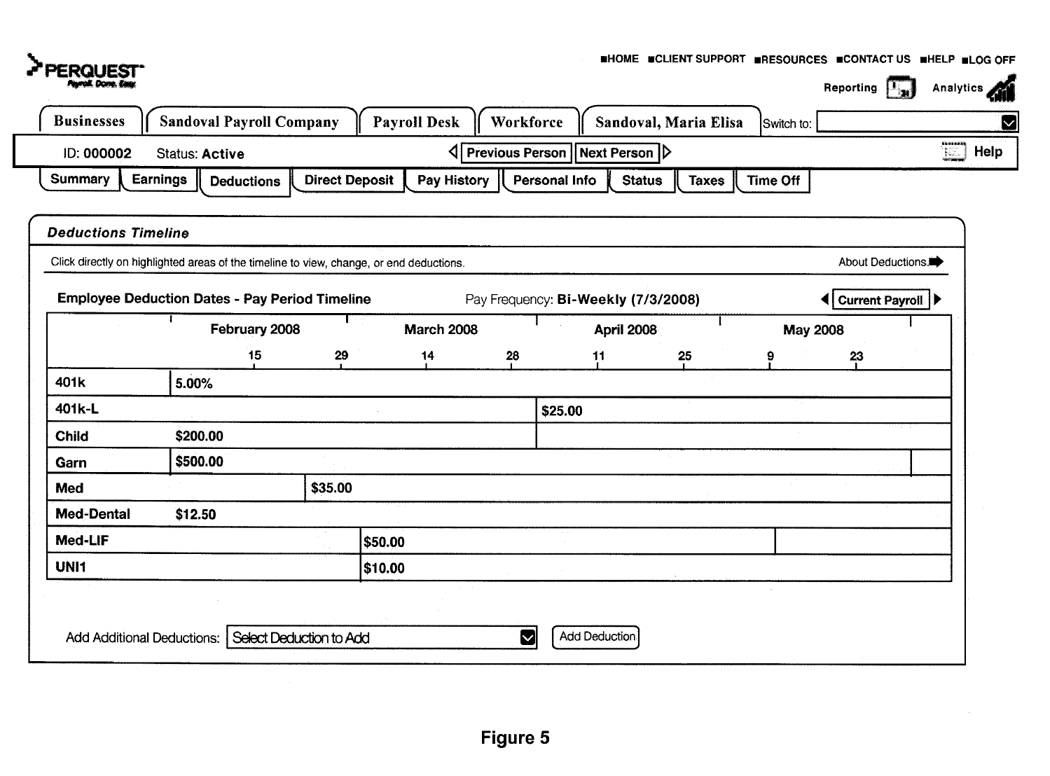

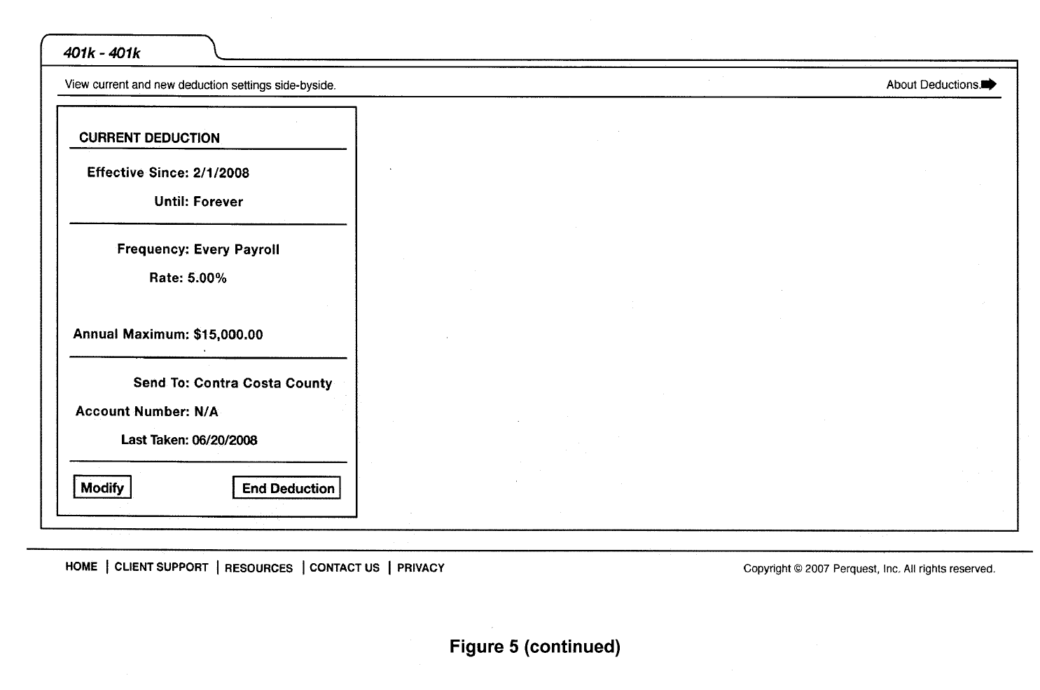

FIG. 5 shows an embodiment of a user interface including a timeline which may reflect data modification made by some data modification interface. In one embodiment of the invention, a data modification interface may include a side by side display. A side by side display which may include a current data region and a new data region, where the current data region contains current data values and a new data region may contain data interaction interfaces or data values corresponding to the current values and substantially mirroring them. A user may interact with data interaction interfaces to modify a data value. Embodiments of a side by side display are described in U.S. application Ser. No. 12/053,467 and is hereby incorporated by reference. The data modification from a side by side display may be reflected in the corresponding timeline.

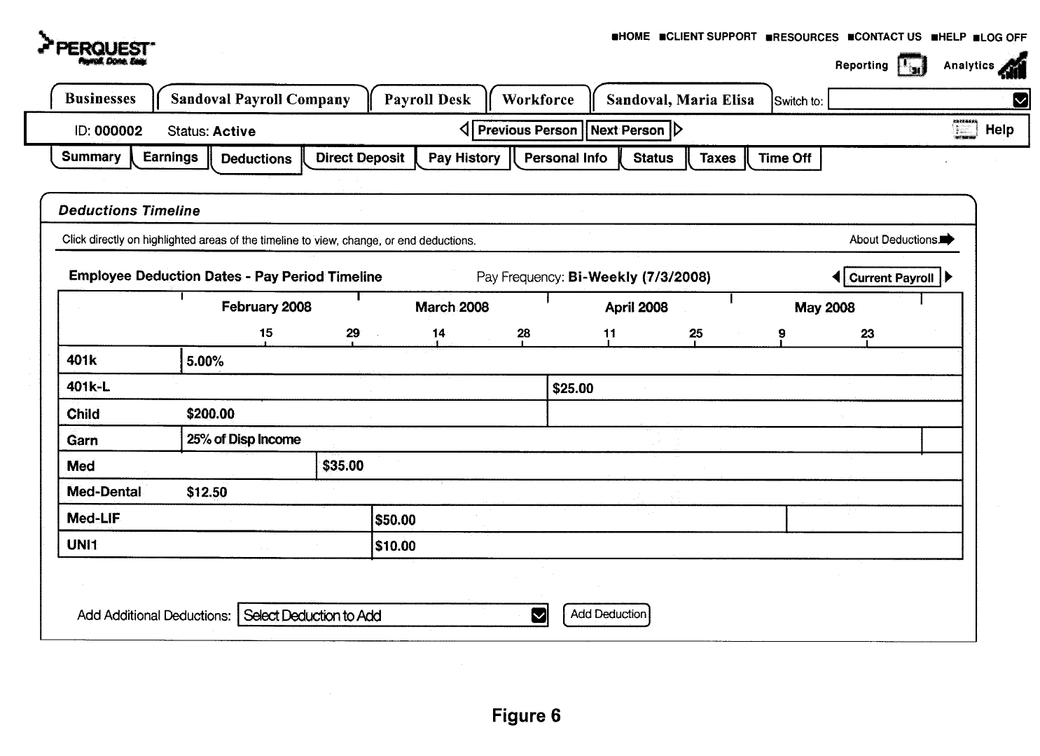

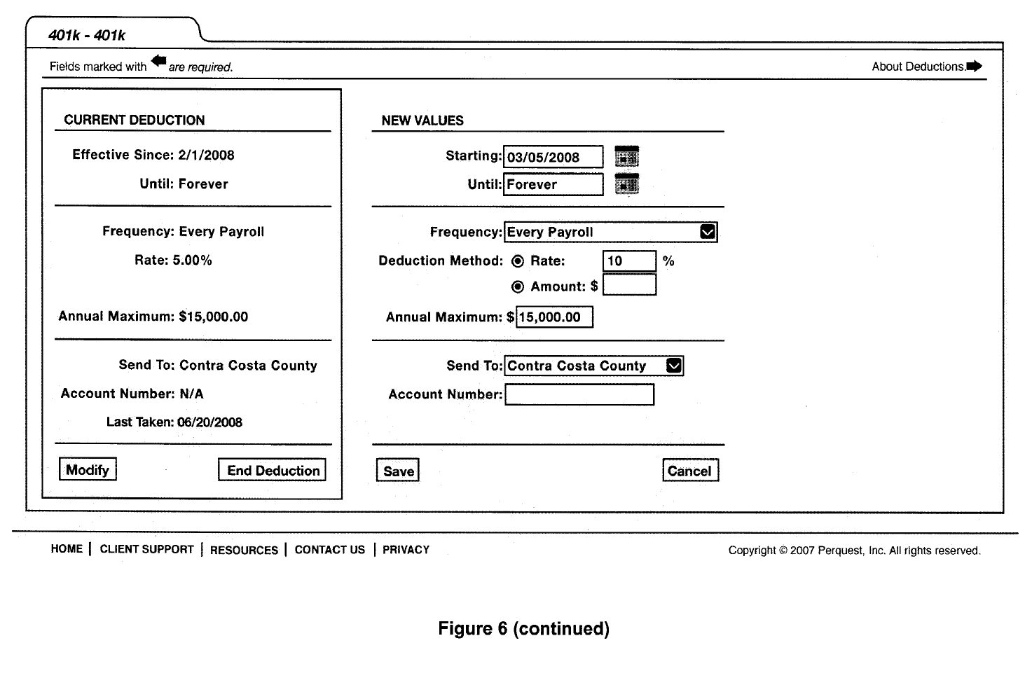

For example, if a deduction for a 401K item were changed to a percentage value starting a certain day in the side by side display, the timeline could indicate the change in the item timeline for 401K. Such a change may occur by a user selecting an item on the item timeline. Selecting an item may cause a current data region with current values relating to the item to appear. A user may select an option to modify the current values, which may cause a new data region to appear, which may include data interaction interfaces or data values to appear. A user may interact with a data interaction interface to change a value. For instance, as shown in FIG. 6, a user may change an item value and choose to save the change. The change may be reflected in the item timeline by a change indicator.

In accordance with one embodiment of the invention, the timeline and the data modification interface may be displayed together. For example, a side by side display may be labeled as an item of the timeline. In one embodiment of the invention there may be multiple tabs, and the tabs may be selected and may display a timeline relating to the selected tab. Similarly, the side by side display may relate to an item selected from an item timeline, or may relate to an item to be added to the item timeline.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A graphical timeline for displaying human capital management data comprising:
a plurality of time period indicators covering a defined time interval; and
one or more human capital management item timelines each divided by the time period indicators, wherein each human capital management item timeline includes:
an initial data value for a human capital management item at an earlier time period on the payroll item timeline; and
a change indicator on the human capital management item timeline that indicates at a later time a data value change for the human capital management item together with a new data value.

2. The graphical timeline of claim 1 further comprising an interface for adding new items.

3. The graphical timeline of claim 1 wherein the plurality of time period indicators indicate pay periods.

4. The graphical timeline of claim 1 wherein at least one human capital management items relates to payroll data.

5. The graphical timeline of claim 4 wherein the human capital management items include at least one of: 401K, CAF, GamIRS, ChSupp, miscellaneous, and advance data.

6. The graphical timeline of claim 1 wherein the new data value is blank if the change indicator indicates the end of the human capital management item.

7. The graphical timeline of claim 1 wherein the change indicator includes a color change within the human capital management item timeline for the new data value or for the end of the human capital management item.

8. The graphical timeline of claim 1 further comprising time passage indicators corresponding to a calendar time period.

9. The graphical timeline of claim 3 further comprising an indicator denoting a next payroll time.

10. A graphical interface for a payroll management system comprising:
a plurality of visually mapped payroll item timelines that are divided into selected time intervals, wherein each payroll item timeline includes: a first data value corresponding to a first period of time for a selected payroll item; and a second data value corresponding to a second period of time for the selected payroll items.

11. The graphical interface of claim 10 wherein the first data value and the second data value are the same.

12. A graphical interface for a human capital management system comprising:
a plurality of graphical human capital management item timelines that are divided into selected time intervals, wherein at least one human capital management item timeline includes: a first data value corresponding to a first period of time for a selected human capital management item; and a second data value corresponding to a second period of time for the selected human capital management items.

13. A method for displaying human capital management data comprising:
displaying a graphical timeline with a plurality of time period indicators covering a defined time interval;
displaying one or more human capital management item timelines divided by the plurality of time period indicators;
showing an initial data value for a human capital management item at an earlier time period on the human capital management item timeline; and
showing a change indicator on the human capital management item timeline that indicates at a later time a data value change for the human capital management item together with a new data value.

14. The method of claim 13 further comprising adding an additional human capital management item, with its own human capital management item timeline.

15. The method of claim 13 wherein the new data value is blank if the change indicator indicates the end of the human capital management item.

16. The method of claim 13 further comprising displaying information about a human capital management item when a pointing device indicator is over a human capital management item timeline.

17. The method of claim 13 further comprising displaying information about a human capital management item when a user clicks on a human capital management item timeline.

18. The method of claim 16 or 17 wherein displaying information includes at least one of the following: displaying information on a popup, displaying information in a new window, or displaying information in a page so that the user navigates away from the previous page.

19. A method for displaying payroll data comprising:
displaying a plurality of visually mapped payroll item timelines that are divided into selected time intervals, wherein each payroll item timeline includes: a first data value corresponding to a first period of time for a selected payroll item; and a second data value corresponding to a second period of time for the selected payroll items.

20. The method of claim 19 wherein the first data value and the second data value are the same.

21. The graphical timeline of claim 1 wherein the change indicator indicates a change that occurred through use of a data modification interface.

22. The graphical timeline of claim 21 wherein the data modification interface is a side by side display.

23. The method of displaying payroll data of claim 13 wherein showing a change indicator on the human capital management item timeline reflects a change made by modifying human capital management data through a data modification interface.

24. The method of claim 23 wherein the data modification interface is a side by side display.
